(19) United States
(12) Patent Application Publication
(10) Pub. No.: US 2010/0318894 A1
(43) Pub. Date: Dec. 16, 2010

(54) Modifications to Editable Elements of Web Pages Rendered in Word Processor Applications

(75) Inventors: Alan Billharz, Kirkland, WA (US); Michael Monarch, Hingham, MA (US); Marta Rey-Babarro, Seattle, WA (US)

Correspondence Address: MERCHANT & GOULD (MICROSOFT), P.O. BOX 2903, MINNEAPOLIS, MN, 55402-0903, US

(73) Assignee: MICROSOFT CORPORATION, Redmond, WA (US)

(21) Appl. No.: 12/483,109

(22) Filed: Jun. 11, 2009

(51) Int. Cl. G06F 17/00; G06F 15/16; G06F 3/048

(52) U.S. Cl. 715/234; 709/203; 715/781; 715/255; 709/206

(57) ABSTRACT

A word processor application presents a word processor user interface containing a word processor document. The word processor application generates the word processor document by rendering a web page file. The word processor document includes editable elements and non-editable elements. The web page file indicates which elements of the web page file are rendered as editable elements and which elements of the web pages are rendered as non-editable elements. In some instances, the non-editable elements are common to each web page in a web site. The user edits the content of the editable elements. When the user saves the word processor document, the client computing system sends a page modification request to a server computing system. In response, the server computing system modifies the web page file such that corresponding editable elements of the web page file specify the content of the editable elements in the word processor document.

### BACKGROUND

Millions of people use word processor applications on a daily basis. For this reason, many people feel comfortable working with word processor applications. In contrast, relatively few people are accustomed to working with web page editing applications. For this reason, fewer people feel comfortable working with web page editing applications. Because many people do not feel comfortable working with web page editing applications, people frequently do not feel empowered to make small changes to web pages they are allowed to edit. For instance, people might not feel empowered to correct spelling mistakes, update personal biography pages, add photos, add news items, or modify contact information.

### SUMMARY

A word processor application presents a word processor user interface containing a word processor document. The word processor application generates the word processor document by rendering a web page file. The word processor document includes editable elements and non-editable elements. The web page file indicates which elements of the web page file are rendered as editable elements and which elements of the web pages are rendered as non-editable elements. In some instances, the non-editable elements are common to each web page in a web site. The user edits the content of the editable elements. When the user saves the word processor document, the client computing system sends a page modification request to a server computing system. In response, the server computing system modifies the web page file such that corresponding editable elements of the web page file specify the content of the editable elements in the word processor document.

This summary is provided to introduce a selection of concepts in a simplified form. These concepts are further described below in the Detailed Description. This summary is not intended to identify key features or essential features of the claimed subject matter, nor is this summary intended as an aid in determining the scope of the claimed subject matter.

### BRIEF DESCRIPTION OF THE DRAWINGS

FIG. 1 is a block diagram illustrating an example system in which a user modifies a web page using a word processor application.

FIG. 2 is a block diagram illustrating example logical components of a server computing system.

FIG. 3 is a block diagram illustrating example logical components of a client computing system.

FIG. 4 is a flowchart illustrating an example operation performed by the client computing system to use a word processor application to modify an existing web page.

FIG. 5 is a flowchart illustrating an example operation performed by the client computing system to use a word processor application to create a new web page.

FIG. 6 is a flowchart illustrating an example operation performed by the client computing system to use e-mail messages to send a page modification request to the server computing system.

FIG. 7 is a flowchart illustrating an example operation performed by the server computing system when the server computing system receives a page modification request.

FIG. 8 is a flowchart illustrating an example operation performed by the server computing system when the server computing system receives an e-mail message.

FIG. 9 is a block diagram illustrating example hardware details of an electronic computing device.

### DETAILED DESCRIPTION

This disclosure is directed to a computing system that enables a user to use a word processor application to modify or create a web page. The web page has a consistent look and feel with other web pages in a website that includes the web page. The techniques of this disclosure are described with reference to the attached figures. It should be appreciated that the attached figures are provided for purposes of explanation only and should not be understood as representing a sole way of implementing the techniques of this disclosure.

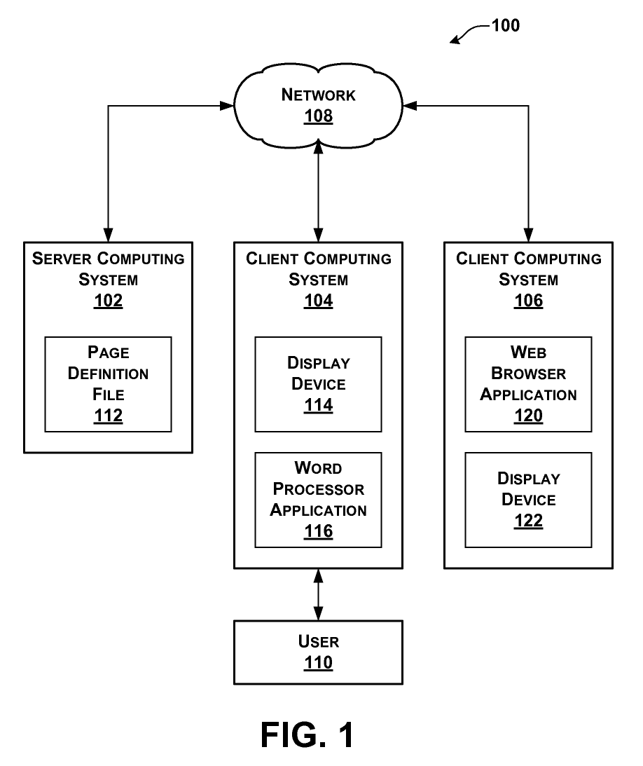

FIG. 1 is a block diagram illustrating an example system 100 in which a user modifies or creates a web page using a word processor application. It should be appreciated that the system 100 is merely an example. For instance, other systems may include more or fewer computing systems than those shown in the example of FIG. 1.

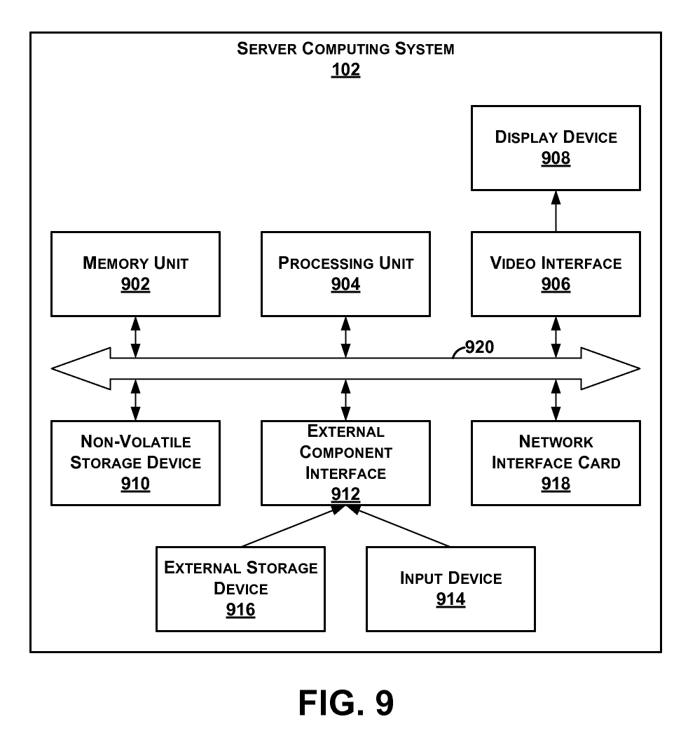

As illustrated in the example of FIG. 1, the system 100 includes a server computing system 102. The server computing system 102 is an electronic computing system. As used in this disclosure, an electronic computing system is a set of one or more physical electronic computing devices. An electronic computing device is a physical machine that comprises physical electronic components. Electronic components are physical entities that affect electrons or fields of electrons in a desired manner consistent with the intended function of an electronic computing device. Example types of electronic components include capacitors, resistors, diodes, transistors, and other types of physical entities that affect electrons or fields of electrons in a manner consistent with the intended function of an electronic computing device. An example physical computing device is described below with reference to FIG. 9.

In addition, the system 100 includes a client computing system 104 and a client computing system 106. The client computing system 104 and the client computing system 106 are electronic computing systems. The client computing system 104 and the client computing system 106 may be a wide variety of different types of electronic computing systems. For example, the client computing system 104 and/or the client computing system 106 may be personal computers, lap top computers, cellular telephones, smartphones, watches, video game consoles, netbooks, personal media players, devices integrated into vehicles, television set top boxes, network appliances, server devices, supercomputers, mainframe computers, and other types of electronic computing systems.

A user 110 interacts with the client computing system 104. The user 110 is an individual human being. The user 110 may be using the client computing system 104 on behalf of one or more enterprises. As used in this disclosure, an enterprise is a natural or legal entity. Example types of legal entities include corporations, partnerships, proprietorships, companies, non-profit corporations, foundations, estates, governmental agencies, and other types of legal entities. The user 110 may interact with the client computing system 104 in a variety of ways. For example, the user 110 may use an input device, such as a keyboard or mouse, directly connected to the client computing system 104 to interact with the client computing system 104. In another example, the user 110 may interact with the client computing system 104 by interacting with a computing system (not shown) that communicates with the client computing system 104.

A network 108 facilitates communication between the server computing system 102, the client computing system 104, and the client computing system 106. The network 108 may be a wide variety of different types of electronic communication networks. For example, the network 108 may be a wide-area network, such as the Internet, a local-area network, a metropolitan-area network, or another type of electronic communication network. The network 108 may include wired and/or wireless data links. A variety of communications protocols may be used in the network 108 including, but not limited to, Ethernet, Transport Control Protocol (TCP), Internet Protocol (IP), Hypertext Transfer Protocol (HTTP), SOAP, remote procedure call protocols, and/or other types of communications protocols.

The server computing system 102 hosts a web page. As used in this disclosure, a web page is a document displayed by a web browser application when the web browser application renders a web page file. A web page file is a file containing markup language text that defines the content and layout of the web page. In other words, the web page is what the web browser application displays when the web browser application renders a web page file. As used in this disclosure, rendering refers to interpreting markup language text to generate a displayable document. Furthermore, as used in this disclosure, a file is a block of arbitrary information storable on a persistent computer-readable data storage medium.

The web page is part of a website hosted by the server computing system 102. A web site is a collection of one or more web pages. A server computing system hosts a web site when the server computing system enables one or more computing systems to access web pages in the web site. Classes of web pages in the web site have elements that make the web pages have a consistent look and feel. Such elements include navigation bars, headers, footers, fonts, styles, and so on.

In different implementations, the web page file may contain different types of markup language text. For example, the web page file may contain text conforming to the Hypertext Markup Language (HTML), the Extensible Hypertext Markup Language (XHTML), or another markup language that can be rendered by a web browser application.

The server computing system 102 stores a page definition file 112. The page definition file 112 is a file comprising a character string conforming to a markup language. The character string defines a hierarchy of markup language elements. The hierarchy of markup language elements defines the content and layout of the web page. Each markup language element in the hierarchy of markup language elements defines an element of the web page.

As used in this disclosure, an element of a web page is a logical sub-part of the web page. Example types of elements in a web page include paragraphs, ordered lists, ordered list items, unordered lists, unordered list items, blocks of text having a given font, underlined blocks of text, bolded blocks of text, frames, tables, table rows, table headers, table columns, anchors, links, titles, addresses, divisions, spans, forms, input elements, buttons, labels for radio buttons, select elements, text areas, and other sub-parts of a web page.

Each of the markup language elements in the page definition file 112 comprises a start tag. The start tag of a markup language element is a character string specifying a type of the page element. Depending on the type of a page element, the start tag of a page element may include one or more attributes. An attribute is a character string that defines a name-value pair. Furthermore, depending on the type of the markup language element, the markup language element may include content. The content of a markup language element is a character string defining the content of an element within a web page. The content of a markup language element may include one or more additional markup language elements. The start of the content of a markup language element is denoted by the start tag of the markup language element and the end of the content of the markup language element is denoted by an end tag.

In some implementations, the page definition file 112 is the same file as the web page file. For example, the page definition file 112 may comprise a character string conforming to HTML. As used in this disclosure, a string conforming to HTML is referred to as a HTML string. A file exclusively comprising a HTML string is referred to as a HTML file. In this example, a web browser application can render the page definition file 112 to generate the web page.

However, in other implementations, the server computing system 102 uses the page definition file 112 to generate the web page file. For example, the page definition file 112 may be an Extensible Markup Language (XML) file. A file exclusively comprising an XML string is referred to herein as an XML file. As used in this disclosure, a character string conforming to XML is referred to as an XML string. In this example, the server computing system 102 dynamically converts the XML file to a HTML file. The HTML file is the web page file. In some example implementations, the server computing system 102 uses extensible stylesheet language transformations to dynamically convert the XML file into the HTML file.

The page definition file 112 comprises one or more editable markup language elements. Each of the editable markup language elements defines an editable element of the web page. An editable element of a web page has content that can be edited by a user of a word processing application. The start tags of the markup language elements comprise attributes that explicitly designate the markup language elements as editable markup language elements. In a first example, the page definition file 112 is an HTML file comprising a paragraph HTML element. Furthermore, in this first example, the start tag of the paragraph HTML element comprises an attribute that explicitly designates the paragraph HTML element as an editable element. In this first example, the paragraph HTML element may appear as “<p editable=YES> . . . </p>”. In a second example, the page definition file 112 is an HTML file comprising a div HTML element. In this second example, the div HTML element has a class attribute that explicitly designates the div HTML element as an editable element. In this second example, the div HTML element may appear as “<div class=“editable”> . . . </div>.”

Each editable element in the page definition file 112 is associated with an element identifier that uniquely identifies each of the editable elements. In one example implementation, the editable elements include id attributes that specify different values. For instance, in this example implementation, where the page definition file 112 is a HTML file, a first editable element may appear as “<div class=“editable” id=“123”> . . . </div>” and a second editable element may appear as “<div class=“editable” id=124”> . . . </div>”.

As illustrated in the example of FIG. 1, the client computing system 104 comprises a display device 114. As used in this disclosure, a display device is a device capable of dynamically displaying visible images. Example types of display devices include computer monitors, television sets, digital image projectors, liquid crystal display (LCD) screens, light emitting diode (LED) arrays, cathode ray tube (CRT) displays, and so on.

Furthermore, as illustrated in the example of FIG. 1, the client computing system 104 executes a word processor application 116. As used in this disclosure, a word processor application is a software application that enables a user to create, view, and edit word processor documents. Example types of word processor applications include the Microsoft Word word processor application, the Google Docs word processor application, the Open Office Writer word processor application, and so on. As used in this disclosure, a word processor document is a document comprising human-readable content (e.g., text) having a specific format that defines how the human-readable content is laid out when the document is physically printed.

As used in this disclosure, a software application is a set of software instructions that, when executed by a processing unit of a computing system, cause the computing system to provide a computerized tool with which a user can interact. As used in this disclosure, a processing unit is a set of one or more physical integrated circuits capable of executing software instructions. As used in this disclosure, a software instruction is a data structure that represents an operation of a processing unit. For example, a software instruction may be a data structure comprising an operation code and zero or more operand specifiers. In this example, the operand specifiers may specify registers, memory addresses, or literal data.

The word processor application 116 causes the client computing system 104 to present a word processor user interface. The word processor user interface is a graphical user interface able to contain at least a portion of a word processor document according to a format that defines how the human-readable content in the word processor document would be laid out when the word processor document is physically printed. The word processor user interface also comprises a set of controls. As used in this disclosure, a control is a graphic element that, when selected by a user, causes a computing system to execute a command. Example types of controls include icons, buttons, and other graphical elements that, when selected by a user, cause a computing system to execute a command.

As described below, the user 110 is able to instruct the word processor application 116 to retrieve a web page file defining the web page, render the web page file as a word processor document, and display the resulting word processor document in the word processor user interface. When the word processor application 116 renders the web page file as the word processor document, the word processor document is generally equivalent visually to the web page that results when the web browser application 120 renders the web page file. In some implementations, rendering the web page file as the word processor document entails converting some or all of the web page file into a word processor file. The word processor file conforms to a file format native to the word processor application 116. In such implementations, the word processor application 116 then renders the word processor file to display the word processor document.

The word processor document includes editable elements and non-editable elements. The editable elements of the word processor document result from the word processor application 116 rendering the editable elements of the word processor file. The non-editable elements of the word processor document result from the word processor application 116 rendering the non-editable elements of the word processor file. Some of the non-editable elements are common to web pages in a web site that includes the web page. These non-editable elements contribute to a look and feel of the web pages in the web site.

When the word processor document is displayed in the word processor user interface, the user 110 is able to edit the contents of editable elements in the word processor document in a manner that the user 110 would ordinarily edit word processor documents in the word processor user interface. However, the user 110 is not able to edit the contents of the non-editable elements in the word processor document. The editable elements and non-editable elements of the word processor document are logical sub-parts of the word process document. For example, the editable elements and the non-editable elements may be include paragraphs, sentences, tables, table cells, phrases, words, or other logical sub-parts of the word processor document.

Each of the editable elements in the word processor document corresponds to a different editable element in the web page file. Each of the editable elements in the word processor document initially contains the contents of the corresponding editable element of the web page. For example, if an editable element of the web page initially specifies the phrase “123 Main Street,” the corresponding editable element of the word processor document initially specifies the phrase “123 Main Street.”

After the user 110 has edited the contents of the editable elements of the word processor application, the word processor application 116 sends a page modification request to the server computing system 102. The server computing system 102 is configured to modify the web page such that each of the editable elements of the web page specifies the contents of the corresponding editable element in the word processor document.

The client computing system 106 executes a web browser application 120. A user of the client computing system 106 is able to use the web browser application 120 to send a resource request to the server computing system 102 for the web page. In response to the resource request for the web page, the server computing system 102 sends to the client computing system 106 a web page file defining the web page. For instance, the server computing system 102 may send the page definition file 112 back to the client computing system 106. In response to receiving the web page file, the web browser application 120 renders the web page file and causes a display device 122 to display the web page.

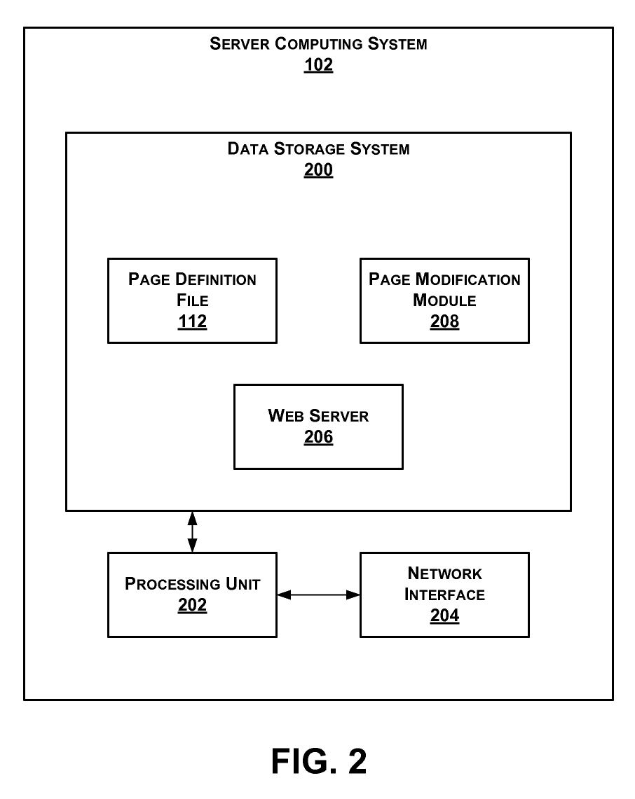

FIG. 2 is a block diagram illustrating example logical components of the server computing system 102. It should be appreciated that FIG. 2 is an example provided for purposes of explanation only. In other instances, the server computing system 102 may contain different logical components. As used in this disclosure, a logical component is a sub-part of a system, the sub-part having a well-defined purpose and functionality.

As illustrated in the example of FIG. 2, the server computing system 102 comprises a data storage system 200, a processing unit 202, and a network interface 204. The network interface 204 enables the server computing system 102 to send data on the network 108 and to receive data from the network 108. As used in this disclosure, a network interface is a set of one or more physical network interface cards. Furthermore, as used in this disclosure, a network interface card is a computer hardware component designed to allow a computing system to communicate over an electronic communication network. In some example implementations, the network interface 204 is able to store data received from the network 108 directly into the data storage system 200 and to directly send on the network 108 data stored in the data storage system 200.

As illustrated in the example of FIG. 2, the data storage system 200 stores the page definition file 112, a web server 206, and a page modification module 208. In implementations where the server computing system 102 comprises a plurality of electronic computing devices and the data storage system 200 comprises a plurality of computer-readable data storage media, one or more of the page definition file 112, the web server 206, and the page modification module 208 may be stored at different computer-readable data storage media and potentially at computer-readable data storage media in different electronic computing devices. For instance, the web server 206 may be stored at a computer-readable data storage medium at a first server device at a server farm and the page definition file 112 may be stored at a plurality of computer-readable data storage media at a second server device in the server farm.

In some example implementations, the web server 206 comprises a set of software instructions. This disclosure includes statements that describe the web server 206 as performing various actions. Such statements should be interpreted to mean that the server computing system 102 performs the various actions when the processing unit 202 executes software instructions of the web server 206.

In some example implementations, the page modification module 208 comprises a set of software instructions. This disclosure includes statements that describe the page modification module 208 as performing various actions. Such statements should be interpreted to mean that the server computing system 102 performs the various actions when the processing unit 202 executes software instructions of the page modification module 208.

The web server 206 receives resource requests from the network 108 via the network interface 204 and responds appropriately to the resource requests. As used in this disclosure, a resource request is a request to perform an action on a resource. Example types of resource requests include get requests that request the web server 206 to return copies of resources to computing systems, delete requests that request the web server 206 to delete resources, post requests that request the web server 206 to submit data to specified resources, and other types of requests to perform actions on resources.

In addition, the web server 206 comprises software instructions that, when executed by the processing unit 202, cause the server computing system 102 to respond appropriately to the resource requests. When the web server 206 receives from a computing system a get resource request that specifies the web page, the web server 206 sends a copy of a web page file to the computing system. The web page file defines the web page. In some implementations, the web server 206 uses the page definition file 112 to generate the web page file. In other definitions, the page definition file 112 is the web page file. As described in detail below, the page modification module 208 modifies the page definition file 112.

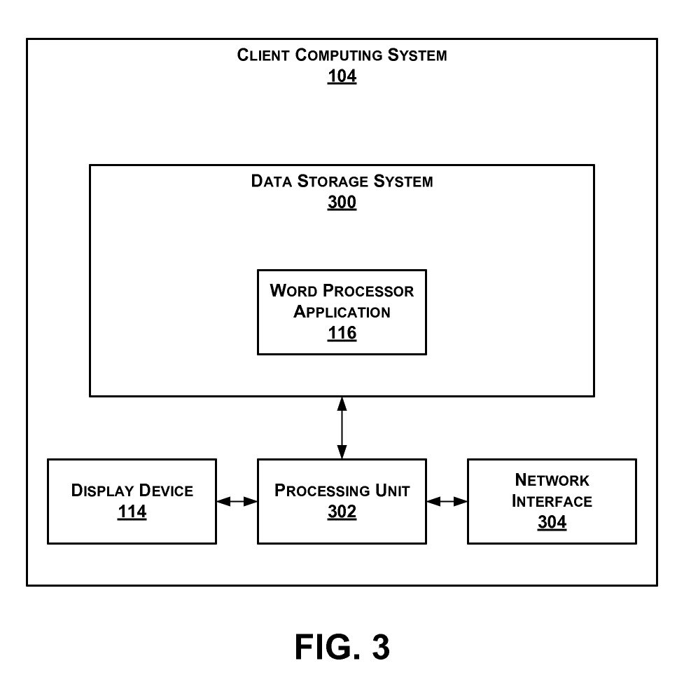

FIG. 3 is a block diagram illustrating example logical components of the client computing system 104. It should be appreciated that FIG. 3 is an example provided for purposes of explanation only. In other instances, the client computing system 104 may contain different logical components.

As illustrated in the example of FIG. 3, the client computing system 104 comprises a data storage system 300, a processing unit 302, a network interface 304, and a display device 306. The network interface 304 enables the client computing system 104 to send data on the network 108 and to receive data from the network 108. The data storage system 300 stores a word processor application 116.

In some example implementations, the word processor application 116 comprises a set of software instructions. This disclosure includes statements describing the word processor application 116 as performing various actions. Such statements should be interpreted to mean that the client computing system 104 performs the various actions when the processing unit 302 executes software instructions of the word processor application 116. As described below, the word processor application 116 enables a user to create, view, and edit word processor documents.

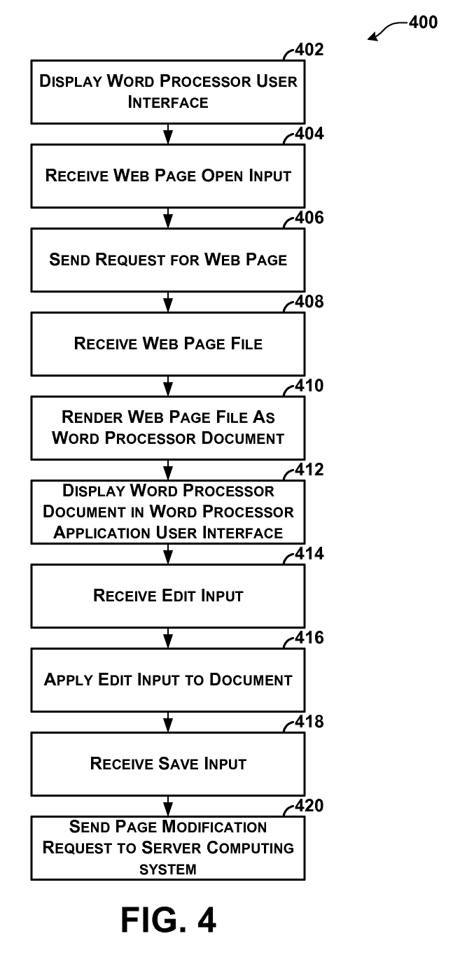

FIG. 4 is a flowchart illustrating an example operation 400 performed by the client computing system 104 to use the word processor application 116 to modify an existing web page. It should be appreciated that the operation 400 is an example provided for purposes of explanation only. In other implementations, operations to use the word processor application 116 to modify an existing web page may involve more or fewer steps, or may involve the steps of the operation 400 in a different order. Furthermore, the operation 400 is explained with reference to FIGS. 1-3. It should be appreciated that other operations to use the word processor application 116 to modify an existing web page may be used in different systems and in computing systems having logical components other than those illustrated in the examples of FIGS. 1-3.

As illustrated in the example of FIG. 4, the operation 400 begins when the word processor application 116 causes the display device 114 to display a word processor user interface (402). The word processor user interface is a graphical user interface. In one example implementation, the word processor user interface comprises a document area and a controls area. When a word processor document is open in the word processor user interface, the document area contains at least a portion of the word processor document. The controls area comprises a set of controls that the user 110 is able use to apply commands to the word processor document in the document area.

When the display device 114 displays the word processor user interface, the word processor application 116 receives a web page open input from the user 110 via the word processor user interface (404). The web page open input indicates to the word processor application 116 that the user 110 wants the word processor application 116 to open a web page for editing in the word processor user interface. As used in this disclosure, receiving input from a user via a user interface entails receiving a selection of a control in the user interface or receiving input while the user interface is in focus.

In different implementations, the word processor application 116 receives the web page open input in different ways. In a first example implementation, the word processor application 116 receives a document open interface input from the user 110 via the word processor user interface. The document open interface input indicates to the word processor application 116 that the user 110 wants the word processor application 116 to display a document open interface.

In response to receiving the document open interface input, the word processor application 116 causes the display device 114 to display a document open interface. The document open interface is a graphical user interface that allows the user 110 to select a word processor document or a web page. In this first example, the document open interface comprises icons representing available word processor documents and web pages. In this first example, the word processor application 116 receives the web page open input via the document open interface when the user 110 selects one of the icons. In a second example, the word processor application 116 displays a user interface that allows the user 110 to enter a Uniform Resource Locator of a web page.

In response to receiving the web page open input, the word processor application 116 automatically sends to the server computing system 102 a resource request requesting the web page (406). For example, the word processor application 116 may send a HTTP “Get” request to the server computing system 102. In this example, the HTTP “Get” request specifies a domain name associated with the server computing system 102 and a path name of the web page.

Subsequently, the word processor application 116 receives a web page file from the server computing system 102 in response to the resource request (408). The web page file defines the web page.

After receiving the web page file, the word processor application 116 renders the web page file as a word processor document (410). The word processor document generally has the same content and layout as the web page. When the word processor application 116 renders the web page file as a word processor document, the word processor application 116 creates editable elements in the word processor document corresponding to each editable element in the web page. Furthermore, when the word processor application 116 renders the web page file as a word processor document, the word processor application creates non-editable elements in the word processor document corresponding to each non-editable element in the web page. As discussed above, an element of a web page is a sub-part of the document. The editable elements and non-editable elements of the word processor document initially have the same content as their corresponding editable elements in the web page.

The word processor application 116 then displays the word processor document in the word processor user interface (412). In one example implementation, when the word processor application 116 displays the word processor document in the word processor user interface, the editable elements of the word processor document are visibly differentiated from other portions of the word processor document. As used in this disclosure, an editable element of a word processor document is visibly differentiated from other parts of the word processor document when a user is able to distinguish a boundary between the editable element of the word processor document and the other parts of the word processor document when the user is looking at the word processor document. For instance, the word processor application 116 may display the word processor document in the word processor user interface such that each of the editable elements of the word processor document is surrounded by a border. In another instance, the word processor application 116 may display the word processor document in the word processor user interface such that areas of the word processor document outside the editable elements of the word processor document are grayed out.

When the word processor document is displayed in the word processor user interface, the word processor application 116 receives edit input from the user 110 via the word processor user interface (412). The edit input indicates that the user 110 wants the word processor application 116 to change the word processor document in a particular manner. For example, the edit input may indicate that the user 110 wants to add a character to the word processor document. In this example, the user 110 may provide the edit input to the word processor application 116 by pressing an appropriate key on a keyboard.

In response to receiving the edit input, the word processor application 116 applies the edit input to the word processor document (416). Applying edit input to a word processor document entails modifying the word processor document such that the word processor document is changed in a manner indicated by the edit input. Although not illustrated in the example of FIG. 4 for the sake of brevity, the word processor application 116 may receive and apply many edit inputs from the user 110. In some example implementations, the word processor application 116 does not apply the edit input when the edit input that indicates that the user 110 wants the word processor application 116 to change something in the word processor document outside the editable elements of the word processor document. Thus, in such example implementations, the user 110 may be able to see all of the content of the word processor document, but only able to edit content in the editable elements of the word processor document.

After the word processor document has applied the edit input to the word processor document, the word processor application 116 receives a save input from the user 110 via the word processor user interface (418). The save input indicates to the word processor application 116 that the user 110 wants the word processor application 116 to save the word processor document to the web page.

In response to receiving the save input, the word processor application 116 automatically sends a page modification request to the server computing system 102 (420). In different implementations, the page modification request comprises different data. In some example implementations, the page modification request comprises a page identifier and one or more blocks of document data. The page identifier identifies the web page. The page identifier may be formatted in a variety of ways. For instance, the page identifier may be a URL of the web page. In another example implementation, the page identifier may be a file system path name of the web page file. Each of the blocks of document data specifies the content of one of the editable elements in the word processor document. Because each of the editable elements in the word processor document corresponds to one of the editable elements in the web page, each of the blocks of document data corresponds to one of the editable elements in the web page. In such implementations, the server computing system 102 is configured to use the blocks of document data to modify the page definition file 112 such that the editable elements in the web page specify the contents specified by corresponding editable elements in the word processor document. Furthermore, in some example implementations, the page modification request may include one or more authentication credentials. In such implementations, the server computing system 102 uses the authentication credentials to determine whether the page modification request is authorized. Example types of authentication credentials include usernames and passwords, one-time passwords, biometric indicators, digital certificates, and other types of information that can be used to determine whether the page modification request is authorized.

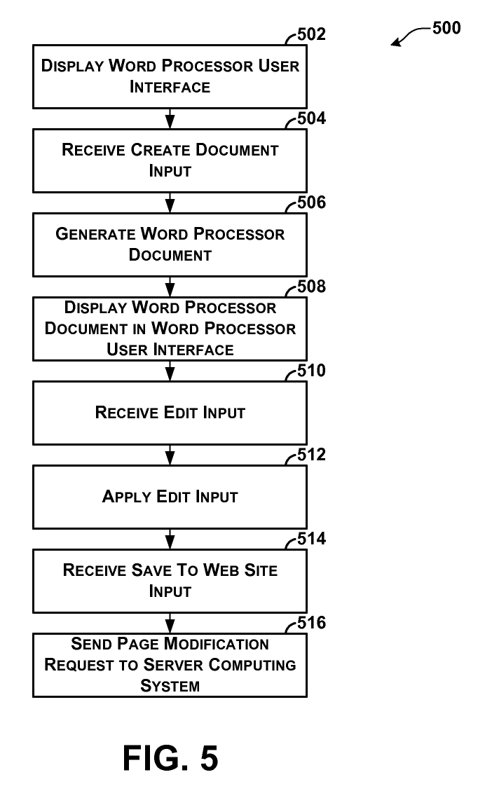

FIG. 5 is a flowchart illustrating an example operation 500 performed by the client computing system 104 to use the word processor application 116 to create a new web page. It should be appreciated that the operation 500 is an example provided for purposes of explanation only. In other implementations, operations to use the word processor application 116 to create a new web page may involve more or fewer steps, or may involve the steps of the operation 500 in a different order. Furthermore, the operation 500 is explained with reference to FIGS. 1-3. It should be appreciated that other operations to use the word processor application 116 to create a new web page may be used in different systems and in computing systems having logical components other than those illustrated in the examples of FIGS. 1-3.

As illustrated in the example of FIG. 5, the operation 500 begins when the word processor application 116 displays a word processor user interface on the display device 114 (502). Initially, the word processor user interface does not contain a word processor document.

Subsequently, the word processor application 116 receives a create document input from the user 110 via the word processor user interface (504). The create document input indicates to the word processor application 116 that the user 110 wants the word processor application 116 to create a new word processor document. The word processor application 116 may receive the create document input in a variety of ways. For example, the word processor application 116 may receive the create document input from the user 110 when the user 110 clicks on a particular icon in the word processor user interface.

In response to receiving the create document input, the word processor application 116 automatically generates a new word processor document (506). In some implementations, when the word processor application 116 generates the new word processor document, the word processor application 116 generates a temporary file to store the data of the new word processor document. In such implementations, the word processor application 116 automatically deletes the temporary file when the word processor application 116 receives input from the user 110 to save the word processor document as a particular word processor file. Furthermore, in some implementations, the word processor application 116 creates a temporary web page file instead of a temporary word processor document file. A word processor document file is a file that contains data that the word processor application 116 natively uses to store word processor documents.

After the word processor application 116 creates the new word processor document, the word processor application 116 automatically displays the new word processor document in the word processor user interface (508). In implementations where the word processor application 116 creates a temporary web page file in response to the create document input, the word processor application 116 renders the temporary web page file to generate the new word processor document. In some circumstances, the new word processor document may be too large for the display device 114 to display at once. Consequently, in such circumstances, the word processor user interface only contains a portion of the new word processor document at a given time. In some implementations, the word processor user interface includes scroll bars that allow the user 110 to scroll through the new word processor document, thereby enabling the user 110 to see the entire new word processor document.

When the word processor application 116 displays the new word processor document in the word processor user interface, the word processor application 116 receives edit input from the user 110 via the word processor user interface (510). The edit input indicates that the user 110 wants the word processor application 116 to change the new word processor document in a particular manner. For example, the edit input may indicate that the user 110 wants to add a character to the new word processor document. In this example, the user 110 may provide the edit input to the word processor application 116 by pressing an appropriate key on a keyboard.

In response to receiving the edit input, the word processor application 116 applies the edit input to the new word processor document (512). Although not illustrated in the example of FIG. 5 for the sake of brevity, the word processor application 116 may receive and apply many edit inputs from the user 110.

Subsequently, the word processor application 116 receives a save-to-website input from the user 110 (514). The save-to-website input indicates to the word processor application 116 that the user 110 wants the word processor application 116 to save the new word processor document to a website. In different implementations, the word processor application 116 receives the save-to-web site input in different ways. In a first example, the word processor application 116 may first receive from the user 110 an input that instructs the word processor application 116 to display a save-to-website dialog box. The save-to-website dialog box is a user interface that enables the user 110 to instruct the word processor application 116 that the user 110 wants to save the word processor document as a web page in a website hosted by the server computing system 102. For instance, the save-to-website dialog box may enable the user 110 to input a file name and a storage location. The storage location may be local to the client computing system 104 or may be at the server computing system 102. In a second example implementation, the word processor application 116 receives the save-to-website input when the word processor application 116 receives a particular keystroke combination while the word processor user interface is in focus. In a third example implementation, the user 110 selects a segment of text within the new word processor document. Next, in this third example implementation, the user 110 selects a control associated with saving the selection to a website. In this third example, the save-to-website input indicates to the word processor application 116 that the user 110 wants the word processor application 115 to save only the selected segment of text to a web site

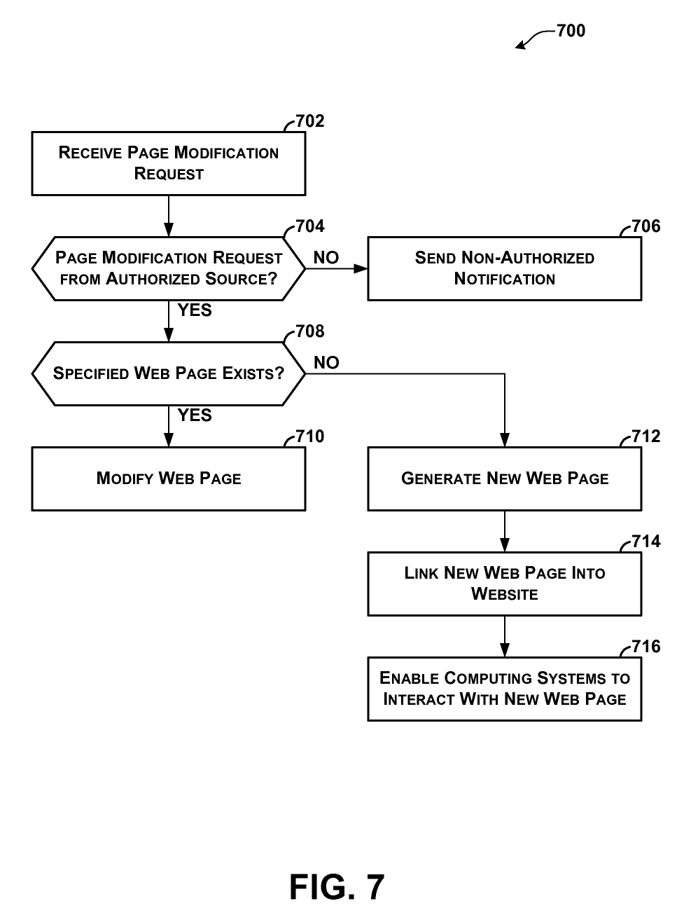

In response to receiving the save-to-website input, the word processor application 116 sends a page modification request to the server computing system 102 (516). As discussed above, in some implementations, the page modification request comprises at least a page identifier and one or more blocks of document data. In such implementations, the page identifier identifies a new web page and the blocks of document data specify the contents of the editable elements of the word processor document. As described below with reference to the example of FIG. 7, the server computing system 102 is, in some implementations, configured to use the blocks of document data to create a new web page in response to receiving the page modification request. The new web page contains an element that specifies the content of the new word processor document. In addition, the new web page contains non-editable elements common to other web pages in the website. The non-editable elements common to other web pages in the website are look-and-feel elements. Look-and-feel elements of a web page are elements of the web page that contribute to the look and feel of the web page. In this way, the new web page has the same look and feel as other web pages in the website.

In some implementations, the word processor application 116 sends the page modification request to the server computing system 102 securely. In some of these implementations, the word processor application 116 prompts the user 110 to provide one or more authentication credentials prior to sending the page modification request. In these implementations, the word processor application 116 sends the authentication credentials with the page modification request.

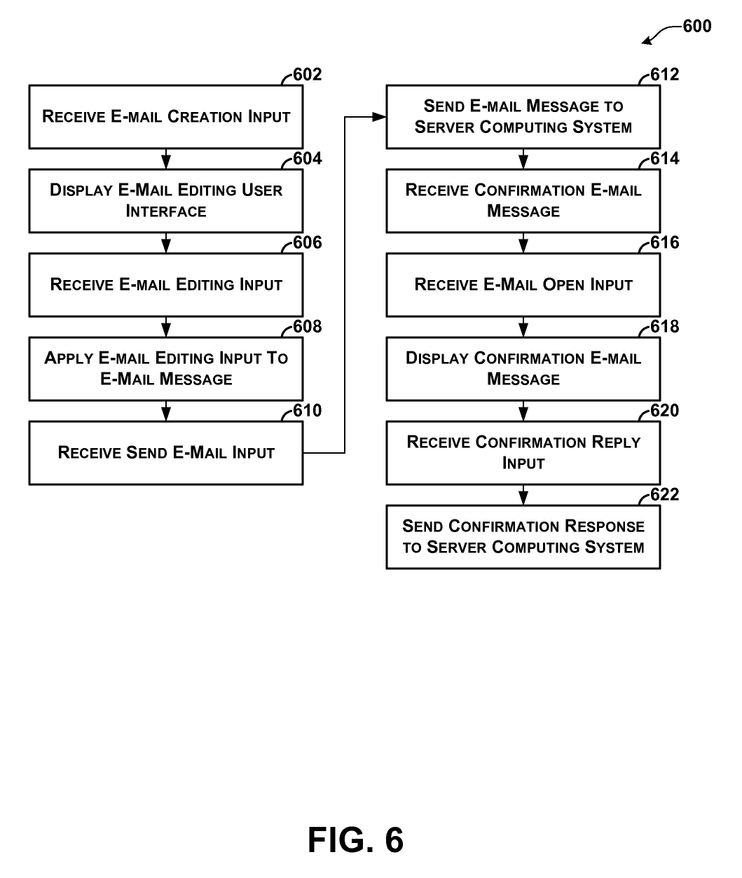

FIG. 6 is a flowchart illustrating an example alternate operation 600 performed by the client computing system 104 to use an e-mail message to send a page modification request to the server computing system 102. It should be appreciated that the operation 600 is an example provided for purposes of explanation only. In other implementations, operations to use e-mail messages to send a page modification request to the server computing system 102 may involve more or fewer steps, or may involve the steps of the operation 600 in a different order. Furthermore, the operation 600 is explained with reference to FIGS. 1-3. It should be appreciated that other operations to use e-mail messages to send a page modification request to the server computing system 102 may be used in different systems and in computing systems having logical components other than those illustrated in the examples of FIGS. 1-3.

As illustrated in the example of FIG. 6, the operation 600 begins when the word processor application 116 receives document creation input from the user 110 (602). The document creation input indicates to the word processor application 116 that the user 110 wants the word processor application 116 to create a new word processor document. In response to receiving the document creation input, the word processor application 116 automatically generates a new word processor document and displays the new word processor document in the word processor user interface (604). Initially, the new word processor document is a single editable element.

Subsequently, the word processor application 116 receives edit input (606). The edit input indicates to the word processor application 116 that the user 110 wants to change the new word processor document in a particular manner. For instance, the edit input may indicate that the user 110 wants to add text or photos to the new word processor document. In response to receiving the edit input, the client computing system 104 automatically modifies the new word processor document in the manner indicated by the edit input (608). Although not illustrated in the example of FIG. 6 for the sake of brevity, the client computing system 104 may receive and apply multiple edit inputs from the user 110. In this way, the user 110 is able to edit the new word processor document.

By providing edit inputs to the word processor application 116, the user 110 edits the new word processor document such that the new word processor document includes at least some content. Furthermore, the word processor application 116 provides e-mailing controls in the word processor user interface. The e-mailing controls include at least a “to” control that allows the user 110 to input an e-mail address to send an e-mail message to. In one example implementation, the user 110 enters an e-mail address that includes a page identifier that identifies a web page and an element identifier that identifies an editable element in the web page. For example, the user 110 may enter the e-mail address “page1.contact-info-element@mypage.com” in the “to” control and may enter “123 Main Street, Minneapolis, Minn. 55402” in the new word processor document. In this example, “page1” is a page identifier and “contact-info-element” is the element identifier, and “123 Main Street, Minneapolis, Minn. 55402” is a block of document data.

After applying the e-mail editing input to the new word processor document, the word processor application 116 receives a send e-mail input (610). The send e-mail input indicates to the word processor application 116 that the user 110 wants to send the new word processor document as an e-mail message. In different implementations, the word processor application 116 may receive the send e-mail input in different ways. For instance, in one implementation, the word processor application 116 receives the send e-mail input when the user 110 clicks on a send control in the window or presses a combination of keys on a keyboard while the window is in focus.

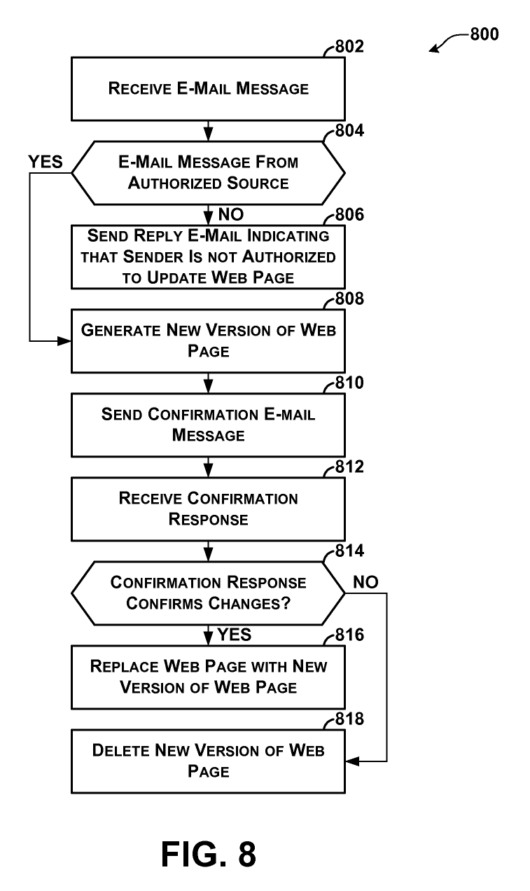

In response to receiving the send e-mail input, the word processor application 116 automatically sends an e-mail message to the server computing system 102 (612). The body of the e-mail message contains the content of the new word processor document. The “to” field of the e-mail message contains the e-mail address entered by the user 110 into the “to” control. As discussed below with regard to the example of FIG. 8, the server computing system 102 is configured to generate a modified version of the web page. In the modified version of the web page, the editable element specified by the element identifier specifies the content of the new word processor document. In one example implementation, the content of the new word processor document replaces the content of the editable element of the web page. In another example implementation, the content of the new word processor document is appended to existing content of the editable element in the web page. In either case, the editable element of the web page specifies the content of the new word processor document. In some implementations, the e-mail message includes data indicating whether the server computing system 102 is to replace the content of the editable element of the web page or is to append the content of the new word processor document to existing content of the editable element of the web page.

Subsequently, the client computing system 104 receives a confirmation e-mail message from the server computing system 102 (614). The confirmation e-mail message prompts the user 110 to confirm that the user 110 wants to accept the modified version of the web page. In different implementations, the confirmation e-mail message prompts the user 110 to confirm that the user 110 wants to accept the modified version of the web page in different ways. For example, the confirmation e-mail message may comprise a “confirm” hyperlink and a “reject” hyperlink. To help the user 110 decide whether the user 110 wants to replace the web page with a modified version of the web page, the confirmation e-mail message may, in one example implementation, contain a hyperlink to the modified version of the web page. By selecting the hyperlink, the user 110 causes the client computing system 104 to launch a web browser application that displays the modified version of the web page. The user 110 is then able to review the modified version of the web page to ensure that modifications to the web page are correct. In some example implementations, the web browser application also displays the current version of the web page. In this way, the user 110 is able to compare the current version of the web page to the modified version of the web page. In another example implementation, the confirmation e-mail message contains an image of the modified version of the web page and an image of the current version of the web page. In this example implementation, the user 110 is able to compare the modified version of the web page and the current version of the web page within the confirmation e-mail message.

After the client computing system 104 receives the confirmation e-mail message, the client computing system 104 receives an e-mail open input from the user 110 (616). The e-mail open input indicates to the client computing system 104 that the user 110 wants to view the confirmation e-mail message. In response to receiving the e-mail open input, the client computing system 104 automatically causes the display device 114 to display the confirmation e-mail message (618).

When the confirmation e-mail message is displayed, the client computing system 104 receives confirmation reply input from the user 110 (620). The confirmation reply input indicates to the client computing system 104 whether the user 110 wants to accept the modified version of the web page. In different implementations, the client computing system 104 receives the confirmation reply input in different ways. For instance, in the example above where the confirmation e-mail message comprises a “confirm” hyperlink and a “reject” hyperlink, the client computing system 104 receives the confirmation reply input when the user 110 selects one of the hyperlinks. In another instance, the client computing system 104 receives the confirmation reply input when the user 110 instructs the client computing system 104 to send a new e-mail message to the server computing system 102. The new e-mail message comprises a confirmation indicator indicating whether or not the user 110 wants to accept the modified version of the web page.

In response to receiving the confirmation reply input, the client computing system 104 automatically sends a confirmation response to the server computing system 102 (622). In different implementations, the client computing system 104 sends the confirmation response to the server computing system 102 in different ways. For instance, in the example above where the confirmation e-mail message comprises a “confirm” hyperlink and a “reject” hyperlink, the client computing system 104 sends the confirmation response to the server computing system 102 by sending resource requests to different resources hosted by the server computing system 102. In the example above where the user 110 instructs the client computing system 104 to send an e-mail message, the client computing system 104 sends the confirmation response to the server computing system 102 by sending the new e-mail message. In some implementations, the client computing system 104 sends the confirmation response securely. For instance, the client computing system 104 may use SSL to send the confirmation response.

FIG. 7 is a flowchart illustrating an example operation 700 performed by the server computing system 102 when the server computing system 102 receives a page modification request. It should be appreciated that the operation 700 is an example provided for purposes of explanation only. In other implementations, operations performed by the server computing system 102 when the server computing system 102 receives a page modification request may involve more or fewer steps, or may involve the steps of the operation 700 in a different order. Furthermore, the operation 700 is explained with reference to FIGS. 1-3. It should be appreciated that other operations performed by the server computing system 102 when the server computing system 102 receives a page modification request may be used in different systems and in computing systems having logical components other than those illustrated in the examples of FIGS. 1-3.

As illustrated in the example of FIG. 7, the operation 700 begins when the page modification module 208 receives a page modification request from the client computing system 104 (702). As discussed above, in some example implementations, the page modification request includes a page identifier and at least one block of document data. The page identifier identifies a web page. Each block of document data corresponds to a different editable element in the web page. For example, if the web page has two editable elements, the page modification request may have two blocks of document data. In another example, if the web page has two editable elements, the page modification request may include one block of document data corresponding to one of the editable elements of the web page. That is, the page modification request does not need to include a block of document data for every editable element of the web page. As discussed below, the page modification module 208 uses data in the blocks of document data to modify the web page such that each of the editable elements in the web page specifies the content of a corresponding editable element of the word processor document.

In different implementations, the blocks of document data may be formatted in different ways. In a first example implementation, the blocks of document data are formatted in HTML. In a second implementation, the blocks of document data are formatted in a format native to the word processor application 116. In this second example implementation, the page modification module 208 automatically converts the content of the editable elements of the word processor document from a format native to the word processor application 116 to blocks of HTML.

In response to receiving the page modification request, the page modification module 208 determines whether the page modification request is from an authorized source (704). As used in this disclosure, an authorized source is a person having authorization to edit or create web pages in a web site hosted by the server computing system.

The page modification module 208 may determine that whether the page modification request is from an authorized source in a variety of ways. For example, the page modification module 208 may determine that the page modification request is from an authorized source when the page modification request is received via a secure network connection. In another example, the page modification module 208 may determine that the page modification request is from an authorized source when the document data is digitally signed by a person who is authorized to edit or create web pages at the web site.

If the page modification request is not from an authorized source (“NO” of 704), the page modification module 208 sends to the client computing system 104 a notification that the page modification request is not from an authorized source (706). In different implementations, the notification may assume different forms. For instance, in one example implementation, the notification may be an e-mail message sent by the server computing system 102 to an e-mail account associated with the user 110. In a second example, the page modification request is a HTTP request message. In this second example, the notification is a HTTP response message comprising a status code indicating that the page modification request is not authorized.

The page modification module 208 then determines whether the page identifier in the page modification request identifies an existing web page hosted by the server computing system 102 (708). If the page modification module 208 determines that the page identifier in the page modification request identifies an existing web page hosted by the server computing system 102 (“YES” of 708), the page modification module 208 modifies the web page identified by the page identifier such that each of the editable elements of the web page specifies the content specified by corresponding ones of the blocks of document data in the page modification request (710). In different implementations, the page modification module 208 modifies the web page in different ways. In a first example implementation, the blocks of document data are formatted as blocks of HTML code. In this first example implementation, the page modification module 208 modifies the web page by modifying the page definition file 112 such that the blocks of HTML code replace or are appended to the content of corresponding ones of the editable elements of the web page. In a second example implementation, the blocks of document data are formatted in a format native to the word processor application 116. In this second example implementation, the page modification module 208 converts the blocks of document data into blocks of HTML code and then modifies the page definition file 112 such that the blocks of HTML code replace or are appended to the content of corresponding ones of the editable elements of the web page.

On the other hand, if the page modification module 208 determines that the page identifier in the page modification request does not identify an existing web page hosted by the server computing system 102 (“NO” of 708), the page modification module 208 generates a new page definition file (712). The new page definition file defines the content and layout of a new web page. The new page definition file includes a markup language element that specifies the content specified by the block of document data in the page modification request. For example, if the block of document data specifies the phrase “The weather is fine,” the new web page includes a markup language element containing the phrase “The weather is fine.”

In some implementations, the page modification module 208 uses a web page template file to generate the new page definition file. The web page template file comprises a set of default non-editable markup language elements. The default markup language elements define default non-editable elements of a class of web pages. The default non-editable elements of web pages in a class of web pages are elements common to each web page in the class of web pages. For example, the default elements of web pages in a class of web pages may include navigation bars, footers, images, color schemes, and/or other structures. The web page template file also comprises at least one editable markup language element. When the page modification module 208 generates the new page definition file, the page modification module 208 generates a copy of the page template file and adds the content specified by the block of document data to the content of the editable markup language element of the copy of the page template file. The copy of the page template file is the new page definition file.

After the page modification module 208 generates the new page definition file, the page modification module 208 automatically links the new web page into a web site (714). Linking the new web page into the web site entails modifying one or more web pages in the web site such that a user can navigate a web browser application to the new web page by selecting a hyperlink in an existing web page in the web site.

Depending on the implementation of the web site, the page modification module 208 may link the new web page into the web site in a variety of ways. For example, a web site may include a site map web page that includes links to each web page in the web site. In this example, the page modification module 208 automatically modifies a page definition file that defines the site map web page such that the site map web page includes a hyperlink to the new web page. In a second example, web pages in the web site include a navigation bar that includes hyperlinks to web pages in the web site. Furthermore, in this second example, the page modification module 208 modifies the navigation bars in each of the web pages such that the navigation bars include a link to the new web page.

After the page modification module 208 links the new web page into the web site, the page modification module 208 enables one or more computing systems to interact with the new web page (716). Depending on the implementation of the server computing system 102, the page modification module 208 enables the computing systems to interact with the new web page in a variety of ways. For example, the page modification module 208 may enable the computing systems to interact with the new web page by copying the new page definition file into a publicly-accessible directory. In another example, the page modification module 208 may enable the computing systems to interact with the new web page by modifying an access flag on the new page definition file.

FIG. 8 is a flowchart illustrating an example operation 800 performed by the server computing system 102 when the server computing system 102 receives an e-mail message. It should be appreciated that the operation 800 is an example provided for purposes of explanation only. In other implementations, operations performed by the server computing system 102 when the server computing system 102 receives an e-mail message may involve more or fewer steps, or may involve the steps of the operation 800 in a different order. Furthermore, the operation 800 is explained with reference to FIGS. 1 and 2. It should be appreciated that other operations performed when the server computing system 102 receives an e-mail message may be used in different systems and in computing systems having logical components other than those illustrated in the examples of FIGS. 1 and 2.

As illustrated in the example of FIG. 8, the operation 800 begins when the page modification module 208 receives an e-mail message from the user 110 (802). The e-mail message specifies a web page hosted by the server computing system 102. In addition, the e-mail message specifies a block of document data. The block of document data corresponds to an editable element in the web page. The block of document data specifies content. Furthermore, in some example implementations, the e-mail message indicates whether the content in the block of document data is to replace the content of the editable element of the web page or is to be appended to the content of the editable element of the web page. In addition, in some example implementations, the e-mail message contains one or more attachments to be copied to a website containing the web page. The attachments may include photos, document files, and other types of files. The attachments may be downloadable from the website as new web pages or as items in a gallery.

After receiving the e-mail message, the page modification module 208 determines whether the e-mail message is from an authorized source (804). In the example of FIG. 8, the page modification module 208 determines that the e-mail message is from an authorized source when the user 110 is authorized to modify the web page identified by the web page identifier and the e-mail message is protected such that the page modification module 208 has some assurance that the e-mail message is authentically from the user 110. For instance, the page modification module 208 may determine that the e-mail message is from an authorized source when the user 110 is authorized to modify the web page and the e-mail message is digitally signed by the user 110.

If the page modification module 208 determines that the e-mail message is not from an authorized source (“NO” of 804), the page modification module 208 sends a reply e-mail message to the sender of the e-mail message (806). The reply e-mail message indicates that the sender of the e-mail message is not authorized to modify the web page.

On the other hand, if the page modification module 208 determines that the e-mail is from an authorized source (“YES” of 804), the page modification module 208 automatically generates a modified version of the web page (808). The modified version of the web page is similar to the web page except that the editable element in the modified version of the web page specifies the content specified by the block of document data. In other words, the modified version of the web page is similar to the web page except that the content specified by the block of document data replaces or is appended to the editable element in the modified version of the web page.

After generating the modified version of the web page, the page modification module 208 sends a confirmation e-mail message to the user 110 (810). The confirmation e-mail message comprises a message that prompts the user 110 to confirm whether the user 110 wants to replace the web page with the modified version of the web page.

Subsequently, the page modification module 208 receives a confirmation response from the user 110 (812). In different implementations, the confirmation response may be formatted in different ways. For instance, the confirmation response may be a confirmation reply e-mail message from the client computing system 104. The confirmation reply e-mail message comprises a confirmation indicator. The confirmation indicator indicates whether the user 110 wants to replace the web page with the modified version of the web page. In another implementation, the page modification module 208 receives the confirmation response from the user 110 when the page modification module 208 receives a request from the user 110 for a resource identified by a URL specified in the confirmation e-mail message.

Upon receiving the confirmation response, the page modification module 208 automatically determines whether the confirmation response indicates that the user 110 wants to replace the web page with the modified version of the web page (814). In some implementations, the page modification module 208 may also automatically determine whether the confirmation response is from an authorized source in response to receiving the confirmation response. If the page modification module 208 determines that the confirmation response indicates that the user 110 does not want to replace the web page with the modified version of the web page (“NO” of 814), the page modification module 208 deletes the modified version of the web page (818).

Otherwise, if the page modification module 208 determines that the confirmation response indicates that the user 110 wants to replace the web page with the modified version of the web page (“YES” of 814), the page modification module 208 replaces the web page with the modified version of the web page (816). When the page modification module 208 replaces the web page with the modified version of the web page, computing systems are able to interact with the modified version of the web page. For instance, the client computing system 106 and/or computing systems controlled by members of the public may be able to interact with the modified version of the web page.

FIG. 9 is a block diagram illustrating example physical components of the server computing system 102. In this example, the server computing system 102 is an electronic computing device. As illustrated in the example of FIG. 9, the server computing system 102 comprises a memory unit 902. The memory unit 902 is a computer-readable data storage medium capable of storing data and/or instructions. The memory unit 902 may be a variety of different types of computer-readable storage media including, but not limited to, dynamic random access memory (DRAM), double data rate synchronous dynamic random access memory (DDR SDRAM), reduced latency DRAM, DDR2 SDRAM, DDR3 SDRAM, Rambus RAM, or other types of computer-readable storage media.

In addition, the server computing system 102 comprises a processing unit 904. As mentioned above, a processing unit is a set of one or more physical electronic integrated circuits that are capable of executing instructions. In a first example, the processing unit 904 may execute software instructions that cause the server computing system 102 to provide specific functionality. In this first example, the processing unit 904 may be implemented as one or more processing cores and/or as one or more separate microprocessors. For instance, in this first example, the processing unit 904 may be implemented as one or more Intel Core 2 microprocessors. The processing unit 904 may be capable of executing instructions in an instruction set, such as the x86 instruction set, the POWER instruction set, a RISC instruction set, the SPARC instruction set, the IA-64 instruction set, the MIPS instruction set, or another instruction set. In a second example, the processing unit 904 may be implemented as an ASIC that provides specific functionality. In a third example, the processing unit 904 may provide specific functionality by using an ASIC and by executing software instructions.

The server computing system 102 also comprises a video interface 906. The video interface 906 enables the server computing system 102 to output video information to a display device 908. The display device 908 may be a variety of different types of display devices. For instance, the display device 908 may be a cathode-ray tube display, an LCD display panel, a plasma screen display panel, a touch-sensitive display panel, a LED array, or another type of display device.

In addition, the server computing system 102 includes a non-volatile storage device 910. The non-volatile storage device 910 is a computer-readable data storage medium that is capable of storing data and/or instructions. The non-volatile storage device 910 may be a variety of different types of non-volatile storage devices. For example, the non-volatile storage device 910 may be one or more hard disk drives, magnetic tape drives, CD-ROM drives, DVD-ROM drives, Blu-Ray disc drives, or other types of non-volatile storage devices.

The server computing system 102 also includes an external component interface 912 that enables the server computing system 102 to communicate with external components. As illustrated in the example of FIG. 9, the external component interface 912 enables the server computing system 102 to communicate with an input device 914 and an external storage device 916. In one implementation of the server computing system 102, the external component interface 912 is a Universal Serial Bus (USB) interface. In other implementations of the server computing system 102, the server computing system 102 may include another type of interface that enables the server computing system 102 to communicate with input devices and/or output devices. For instance, the server computing system 102 may include a PS/2 interface. The input device 914 may be a variety of different types of devices including, but not limited to, keyboards, mice, trackballs, stylus input devices, touch pads, touch-sensitive display screens, or other types of input devices. The external storage device 916 may be a variety of different types of computer-readable data storage media including magnetic tape, flash memory modules, magnetic disk drives, optical disc drives, and other computer-readable data storage media.

In addition, the server computing system 102 includes a network interface card 918 that enables the server computing system 102 to send data to and receive data from an electronic communication network. The network interface card 918 may be a variety of different types of network interface. For example, the network interface card 918 may be an Ethernet interface, a token-ring network interface, a fiber optic network interface, a wireless network interface (e.g., WiFi, WiMax, etc.), or another type of network interface.

The server computing system 102 also includes a communications medium 920. The communications medium 920 facilitates communication among the various components of the server computing system 102. The communications medium 920 may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

The server computing system 102 includes several computer-readable data storage media (i.e., the memory unit 902, the non-volatile storage device 910, and the external storage device 916). Together, these computer-readable storage media may constitute a single data storage system. As discussed above, a data storage system is a set of one or more computer-readable data storage mediums. This data storage system may store instructions executable by the processing unit 904. Activities described in the above description may result from the execution of the instructions stored on this data storage system. Thus, when this description says that a particular logical module performs a particular activity, such a statement may be interpreted to mean that instructions of the logical module, when executed by the processing unit 904, cause the server computing system 102 to perform the activity. In other words, when this description says that a particular logical module performs a particular activity, a reader may interpret such a statement to mean that the instructions configure the server computing system 102 such that the server computing system 102 performs the particular activity.

In example embodiments, the client computing systems 104, 106 can be electronic computing devices configured in a manner similar to that of the server computing system 102 described above.

The techniques of this disclosure may be realized in many ways. For example, the techniques of this disclosure may be realized as a method for enabling a user to use a word processor application to modify a web page. The method comprises causing, by a client computing system, a display device to display a word processor user interface containing at least a portion of a word processor document. The word processor document is a document comprising human-readable content having a specific format that defines how the human-readable content is laid out when the word processor document is physically printed. The word processor user interface is a user interface generated by the client computing system when the client computing system executes the word processor application. The word processor document comprises an editable element. The editable element of the word processor document is a logical sub-part of the word processor document. The method further comprises receiving, at the client computing system, edit input from the user via the word processor user interface. The edit input indicates that the user wants to change the word processor document in a particular manner. The method also comprises in response to receiving the edit input, automatically applying, by the client computing system, the edit input to the word processor document. In addition, the method comprises after applying the edit input to the word processor document, sending, by the word processor application at the client computing system, a page modification request to a server computing system via an electronic communication network. The server computing system hosts the web page. The web page comprises an editable element and a non-editable element. The editable element is a sub-part of the web page. The non-editable element is a sub-part of the web page common to web pages in a web site that includes the web page. The non-editable element contributing to the look and feel of the web page. The server computing system is configured to respond to the page modification request by modifying the web page such that the editable element specifies the content in the editable element of the word processor document.

In another example, the techniques of this disclosure may be realized as a computing system comprising a processing unit. The computing system also comprises a data storage system storing software instructions that, when executed by the processing unit, cause the server computing system to receive a page modification request from a word processor application at a client computing system. The software instructions, when executed by the processing unit, also cause the server computing system to in response to receiving the client computing system, modify a web page such that an editable element of the web page specifies content of an editable element of a word processor document at the client computing system and such that a non-editable element of the web page is unchanged. The non-editable element of the web page is a look-and-feel element common to web pages in a website that includes the web page. The word processor document is a document comprising human-readable content having a specific format that defines how the human-readable content is laid out when the word processor document is physically printed. The software instructions, when executed by the processing unit, also cause the server computing system to receive a resource request from a second client computing system, the resource request being a request for the web page. In response to receiving the resource request, the software instructions, when executed by the processing unit, cause the server computing system to send to the second client computing system a web page file containing data that a web browser application executing at the second client computing system uses to render the web page.

In another example, the techniques of this disclosure may be realized as a system comprising a server computing system, a client computing system, and an electronic communications network that facilitates communication between the server computing system and the client computing system. The client computing system comprises a first processing unit, a display device, a first network interface, and a first data storage system. The first data storage system stores software instructions that, when executed by the first processing unit, cause the client computing system to cause the display device to display a word processor user interface of a word processor application. The software instructions, when executed by the first processing unit, cause the client computing system to receive, from a user of the client computing system, a web page open input via the word processor user interface. The web page open input indicates that the user wants to open a web page for editing in the word processor user interface. The web page comprises an editable element. The editable element is a logical sub-part of the web page. The web page comprises non-editable elements. The non-editable elements are common to other web pages in a website that includes the web page. The non-editable elements contribute to a look and feel of the web pages in the website. The software instructions, when executed by the first processing unit, also cause the client computing system to use the first network interface to send, in response to receiving the web page open input, a first resource request to the server computing system via the electronic communications network, the first resource request requesting the web page. Furthermore, the software instructions, when executed by the first processing unit, cause the client computing system to receive, in response to the first resource request, a web page file from the server computing system. The web page file contains text conforming to a markup language that can be rendered by a web browser application to produce the web page. In addition, the software instructions, when executed by the first processing unit, cause the client computing system to render, in response to receiving the web page file, the web page file into a word processor document. The word processor document is a document comprising human-readable content having a specific format that defines how the human-readable content is laid out when the document is physically printed. The software instructions, when executed by the first processing unit, also cause the client computing system to display the word processor document in the word processor user interface. The word processor document comprises an editable element corresponding to the editable element of the web page. The editable element of the word processor document is a logical sub-part of the word processor document. The word processor document comprises non-editable elements that correspond to the non-editable elements of the web page. In addition, the software instructions, when executed by the first processing unit, cause the client computing system to receive edit input from the user via the word processor user interface. The edit input indicates that the user wants to change content of the word processor document. Moreover, the software instructions, when executed by the first processing unit, cause the client computing system to apply the edit input to the word processor document only when the edit input indicates that the user wants to change content of the editable element of the word processor document. In addition, the software instructions, when executed by the first processing unit, cause the client computing system to receive a save input via the word processor user interface. The save input indicates that the user wants to save the word processor document to the web page. Furthermore, the software instructions, when executed by the first processing unit, cause the client computing system to use the first network interface to send, in response to receiving the save input, a page modification request from the word processor application to the server computing system. The page modification request comprises a page identifier and a block of document data. The page identifier identifies the web page. The block of document data specifies the content of the editable element of the word processor document. The server computing system comprises a second processing unit, a second network interface, and a second data storage system. The second data storage system stores a page definition file that contains a character string conforming to XML. The character string defines a hierarchy of XML elements. The hierarchy of XML elements defines content and layout of each element in the web page. The hierarchy of XML elements comprises an editable XML element. The editable XML element defines content and layout of the editable element of the web page. The editable XML element comprises a start tag, an end tag, and contents. The start tag denotes a start of the contents of the editable XML element and the end tag denotes an end of the contents of the editable XML element. The start tag comprises an attribute that explicitly indicates that the editable XML element is editable using the word processor application. The second data storage system also stores software instructions that, when executed by the second processing unit, cause the server computing system to receive, from the word processor application, the page modification request via the second network interface. The software instructions, when executed by the second processing unit, also cause the server computing system to convert the block of document data into a block of XML data. In addition, the software instructions, when executed by the second processing unit, cause the server computing system to modify, in response to receiving the page modification request, the content of the editable XML element specifies the block of XML data. Furthermore, the software instructions, when executed by the second processing unit, cause the server computing system to receive, after modifying the content of the editable XML element, a second resource request. The second resource request requests the web page. In addition, the software instructions, when executed by the second processing unit, cause the server computing system to convert, in response to receiving the second resource request, the page definition file into the web page file. The software instructions, when executed by the second processing unit, also cause the server computing system to use the second network interface to send the web page file as a response to the second resource request.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method for enabling a user to use a word processor application to modify a web page, the method comprising:
causing, by a client computing system, a display device to display a word processor user interface containing at least a portion of a word processor document, the word processor document being a document comprising human-readable content having a specific format that defines how the human-readable content is laid out when the word processor document is physically printed, the word processor user interface being a user interface generated by the client computing system when the client computing system executes the word processor application, the word processor document comprising an editable element, the editable element of the word processor document being a logical sub-part of the word processor document;
receiving, at the client computing system, edit input from the user via the word processor user interface, the edit input indicating that the user wants to change the word processor document in a particular manner;
in response to receiving the edit input, automatically applying, by the client computing system, the edit input to the word processor document; and
after applying the edit input to the word processor document, sending, by the word processor application at the client computing system, a page modification request to a server computing system via an electronic communication network, the server computing system hosting the web page, the web page comprising an editable element and a non-editable element, the editable element being a sub-part of the web page, the non-editable element being a sub-part of the web page common to web pages in a web site that includes the web page, the non-editable element contributing to the look and feel of the web page, the server computing system configured to respond to the page modification request by modifying the web page such that the editable element specifies the content in the editable element of the word processor document.

2. The method of claim 1, wherein the server computing system stores a page definition file that defines the web page, the page definition file containing a character string conforming to a markup language, the character string defining a hierarchy of markup language elements, the hierarchy of markup language elements defining content and layout of the web page, the hierarchy of markup language elements comprising an editable markup language element, the editable markup language element defining the content and layout of the editable element, the server computing system configured to modify the web page such that the editable element specifies the content in the editable element of the word processor document by modifying content of the editable markup language element.

3. The method of claim 2, wherein the editable markup language element comprises an editing attribute that explicitly indicates that the editable element is allowed to be edited using a word processor application.

4. The method of claim 1, wherein sending the page modification request comprises sending, by the client computing system, a block of document data in the page modification request, the block of document data specifying the content of the editable element of the word processor document, the server computing system configured to use the block of document data to modify the editable element.

5. The method of claim 1,
wherein the method further comprises: prior to sending the page modification request to the server computing system, receiving, at the client computing system, save input from the user; and
wherein sending the page modification request to the server computing system comprises sending, by the client computing system, the page modification request to the server computing system in response to receiving the save input.

6. The method of claim 1,
wherein the method further comprises causing, by the client computing system, the display device to display a save-as dialog box, the save-as dialog box being a user interface that enables the user to instruct the client computing system that the user wants to save the word processor document as a new web page hosted by the server computing system; and
wherein sending the page modification request comprises sending, by the client computing system, the page modification request when the user uses the save-as dialog box to instruct the client computing system to save the word processor document as a new web page hosted by the server computing system.

7. The method of claim 6,
wherein the method further comprises:
receiving, at the client computing system, save input from the user via the word processor user interface;
in response to receiving the save input, automatically causing, by the client computing system, the display device to display the save-as dialog box, the save-as dialog box enabling the user to save the word processor document as a new web page or to save the word processor document in a word processor document file;
saving, by the client computing system, the word processor document in a word processor document file when the user indicates that the user wants to save the word processor document in a word processor document; and
wherein sending the page modification request to the server computing system comprises sending, by the client computing system, the page modification request to the server computing system when the user wants to save the word processor document as a web page.

8. The method of claim 1, wherein causing the display device to display the word processor document in the word processor user interface comprises:
causing, by the client computing system, the editable element of the word processor document to be visually differentiated from other elements of the word processor document.

9. The method of claim 1, further comprising:
prior to causing the display device to display the word processor document in the word processor user interface:
receiving, at the client computing system, a web page file via the electronic communication network, the web page file defining the web page; and
automatically rendering, at the client computing system, the web page file into the word processor document.

10. The method of claim 9, wherein applying the edit input to the word processor document comprises applying, by the client computing system, the edit input to the word processor document only when the edit input indicates that the user wants to change something in the word processor document inside the editable element of the word processor document, the client computing system not applying the edit input to the word processor document when the edit input indicates that the user wants to change something in the word processor document outside the editable element of the word processor document.

11. The method of claim 9, further comprising:
receiving, at the client computing system, a document open interface input from the user via the word processor user interface, the document open interface input indicating that the user wants the client computing system to display a document open interface;
in response to receiving the document open interface input, displaying the document open interface;
receiving, at the client computing system, web page open input from the user via the document open interface, the web page open input indicating that the user wants the client computing system to display the web page in the word processor user interface; and
in response to receiving the web page open input, sending to the server computing system a resource request requesting the web page,
wherein receiving the web page file comprises receiving the web page file in response to the resource request.

12. The method of claim 1, wherein sending the page modification request to the server computing system comprises:
sending, by the client computing system, an e-mail message to the server computing system, the e-mail message containing the page modification request;
receiving, at the client computing system, a confirmation e-mail message from the server computing system, the confirmation e-mail message prompting the user to decide whether to accept a modified version of the web page, the editable element in the new version of the web page specifying the content specified by the editable element of the word processor document;
causing, by the client computing system, the display device to display the confirmation e-mail message; and
after causing the display device to display the confirmation e-mail message, receiving, at the client computing system, confirmation reply input from the user, the confirmation reply input indicating whether the user wants to accept the modified version of the web page; and
sending, by the client computing system, a confirmation response to the server computing system, the confirmation response indicating whether the user wants to accept the modified version of the web page,
wherein the server computing system is configured to replace the web page with the modified version of the web page when the confirmation reply e-mail message indicates that the user wants to accept the modified version of the web page.

13. A server computing system comprising:
a processing unit; and
a data storage system storing software instructions that, when executed by the processing unit, cause the server computing system to:
receive a page modification request from a word processor application at a client computing system;
in response to receiving the client computing system, modify a web page such that an editable element of the web page specifies content of an editable element of a word processor document at the client computing system and such that a non-editable element of the web page is unchanged, the non-editable element of the web page being a look-and-feel element common to web pages in a website that includes the web page, the word processor document being a document comprising human-readable content having a specific format that defines how the human-readable content is laid out when the word processor document is physically printed;
receive a resource request from a second client computing system, the resource request being a request for the web page; and
in response to receiving the resource request, send to the second client computing system a web page file containing data that a web browser application executing at the second client computing system uses to render the web page.

14. The server computing system of claim 13,
wherein the data storage system stores a page definition file that contains a character string conforming to a markup language, the character string defining a hierarchy of markup language elements, the hierarchy of markup language elements defining content and layout of each element in the web page, the hierarchy of markup language elements comprising an editable markup language element, the editable markup language element defining content and layout of the editable element of the web page; and
wherein the software instructions cause the server computing system to modify the web page such that the editable element specifies the content of the editable element of the word processor document by modifying the content of the editable markup language element.

15. The server computing system of claim 14, wherein the markup language is Hypertext Markup Language (HTML).

16. The server computing system of claim 14, wherein the editable markup language element comprises a start tag and an end tag, the start tag comprising an attribute or combination of attributes that indicate that the content of the editable markup language element is editable using the word processor application.

17. The server computing system of claim 14, wherein the software instructions, when executed by the processing unit, further cause the server computing system to convert, in response to receiving the resource request, the page definition file into the web page file.

18. The server computing system of claim 13, wherein after receiving the page modification request and prior to modifying the web page, the software instructions, when executed by the processing unit, further cause the server computing system to:
determine, in response to receiving the page modification request, whether the page modification request identifies an existing web page hosted by the server computing system; and
generate the web page in response to determining that the page modification request does not identify an existing web page hosted by the server computing system.

19. The server computing system of claim 18, wherein the software instructions, when executed by the processing unit, further cause the server computing system to automatically link the web page into a web site by modifying a given web page in the web site such that a user can navigate a web browser application to the web page from the given web page.

20. A system comprising:
a server computing system;
a client computing system; and
an electronic communications network that facilitates communication between the server computing system and the client computing system;
wherein the client computing system comprises:
a first processing unit;
a display device;
a first network interface; and
a first data storage system, the first data storage system storing software instructions that, when executed by the first processing unit, cause the client computing system to:
cause the display device to display a word processor user interface of a word processor application;
receive, from a user of the client computing system, a web page open input via the word processor user interface, the web page open input indicating that the user wants to open a web page for editing in the word processor user interface, the web page comprising an editable element, the editable element being a logical sub-part of the web page, the web page comprising non-editable elements, the non-editable elements being common to other web pages in a website that includes the web page, the non-editable elements contributing to a look and feel of the web pages in the website;
use the first network interface to send, in response to receiving the web page open input, a first resource request to the server computing system via the electronic communications network, the first resource request requesting the web page;
receive, in response to the first resource request, a web page file from the server computing system, the web page file containing text conforming to a markup language that can be rendered by a web browser application to produce the web page;
render, in response to receiving the web page file, the web page file into a word processor document, the word processor document being a document comprising human-readable content having a specific format that defines how the human-readable content is laid out when the document is physically printed;
display the word processor document in the word processor user interface, the word processor document comprising an editable element corresponding to the editable element of the web page, the editable element of the word processor document being a logical sub-part of the word processor document, the word processor document comprising non-editable elements corresponding to the non-editable elements of the web page;
receive edit input from the user via the word processor user interface, the edit input indicating that the user wants to change content of the word processor document;
apply the edit input to the word processor document only when the edit input indicates that the user wants to change content of the editable element of the word processor document;
receive a save input via the word processor user interface, the save input indicating that the user wants to save the word processor document to the web page; and
use the first network interface to send, in response to receiving the save input, a page modification request from the word processor application to the server computing system, the page modification request comprising a page identifier and a block of document data, the page identifier identifying the web page, the block of document data specifying the content of the editable element of the word processor document;
wherein the server computing system comprises:
a second processing unit;
a second network interface; and
a second data storage system, the second data storage system storing:
a page definition file that contains a character string conforming to a Extensible Markup Language (XML), the character string defining a hierarchy of XML elements, the hierarchy of XML elements defining content and layout of each element in the web page, the hierarchy of XML elements comprising an editable XML element, the editable XML element defining content and layout of the editable element of the web page, the editable XML element comprising a start tag, an end tag, and contents, the start tag denoting a start of the contents of the editable XML element and the end tag denoting an end of the contents of the editable XML element, the start tag comprising an attribute that explicitly indicates that the editable XML element is editable using the word processor application; and
software instructions that, when executed by the second processing unit, cause the server computing system to:
receive, from the word processor application, the page modification request via the second network interface;
convert the block of document data into a block of XML data;
modify, in response to receiving the page modification request, the content of the editable XML element specifies the block of XML data;
receive, after modifying the content of the editable XML element, a second resource request, the second resource request requesting the web page;
convert, in response to receiving the second resource request, the page definition file into the web page file; and
use the second network interface to send the web page file as a response to the second resource request.
